(19) United States
(12) Patent Application Publication
(10) Pub. No.: US 2004/0098521 A1
(43) Pub. Date: May 20, 2004

(54) Peripheral management system

(76) Inventor: Patrick Lin, Taipei (TW)

Correspondence Address: MADSON & METCALF, GATEWAY TOWER WEST, SUITE 900, 15 WEST SOUTH TEMPLE, SALT LAKE CITY, UT, 84101

(21) Appl. No.: 10/678,554

(22) Filed: Oct. 3, 2003

(30) Foreign Application Priority Data
Oct. 22, 2002 (TW) 091124409

(51) Int. Cl. G06F 13/12; G06F 13/38

(52) U.S. Cl. 710/72

(57) ABSTRACT

A peripheral management system includes a system chip, a peripheral I/O control device and a control management device. The control management device is electrically connected between the system chip and the peripheral I/O device in series. In a downstream transmission mode, the control management device asserts a first processing signal to the peripheral I/O control device in response to a control signal from the system chip in a first state, and asserts a second processing signal to the peripheral I/O control device in response to an external control signal in a second state. In an upstream transmission mode, the control management device asserts a third processing signal to the system chip in response to another external control signal. Each of the external control signals are asserted by a remote terminal.

### FIELD OF THE INVENTION

The present invention relates to a peripheral management system, and more particular to a system capable of managing peripheral I/O control devices via LPC transmission.

### BACKGROUND OF THE INVENTION

Nowadays, a low pin count (LPC) bus is more and more popular than the prior art external peripheral interface such as ISA bus to be used in the high-end computer system to communicate the south bridge chipset with external peripheral I/O devices. In addition, for improving the reliability of the computer system, a baseboard management controller (BMC) is coupled to the south bridge chipset to monitor the whole operational situation of the computer system. For example, various factors such as the revolving speed of the heat-dissipating fan, the working temperature and the operational voltage are monitored to understand if the computer system works normally. When the computer system crashes, it can be recovered to the normal state at the aid of the BMC.

Please refer to FIG. 1 in which a partial computer architecture associated with the south bridge chipset is shown. The computer system 10 includes a south bridge chipset 11, a baseboard management controller (BMC) 12, a basic input/output system memory (also referred to system BIOS) 13, and an integral input/output (also referred to super I/O) control device 14. The BMC 12 is further coupled to a control management memory 121. The super I/O control device 14 can be electrically connected thereto various peripheral I/O devices such as a keyboard 141, a mouse 142, a floppy disk drive 143 and/or a communication port 144. The above elements, on the other hand, communication with one another via an LPC bus.

The control management memory 121 and the system BIOS 13 are implemented by flash memories. The control management memory 121 stores therein firmware of a plurality of management control commands to be read and executed by the BMC 12. The BMC 12, therefore, determines if the computer system 10 works normally via the heat-dissipating fan sensor, the temperature sensor and the voltage sensor, as mentioned above. Also, the BMC 12 can reset or boot/shut down the computer system when the computer system crashes.

Since the system BIOS 13 is also a flash memory, it can be used to store the firmware of the BIOS, which is provided for the computer system 10 via the south bridge chipset 11. When an input/output operation is performed by the computer system 10, the input/output operation from/to the super I/O device 14 can be performed via the south bridge chipset 11.

The prior art architecture as shown in FIG. 1 is disadvantageous for the following reasons. Once the south bridge chipset 11 crashes and cannot work normally, the connection between the south bridge chipset 11 and the BMC 12, system BIOS 13 or super I/O device 14 via the transmission and control signal S12, S13 or S14 will be disabled, and the entire computer system 10 is interrupted. Since the transmission mode of the system of FIG. 1 is an LPC downstream transmission mode, i.e. the signal transmission among the devices is in a simply downward unidirectional bus transmission mode, the BMC 12 cannot directly reach other devices connected to the LPC bus except the crashed south bridge chip 11. Therefore, the computer system 10 cannot be recovered via a remote terminal. For example, when the BIOS firmware stored in the system BIOS 13 is damaged so as to result in the crash of the south bridge chipset 11, the conventional way to recover the computer system 10 is to update the system BIOS 13 manually. In other words, it requires a specialist to approach the computer system 10 and manually update the damaged BIOS firmware. The maintenance is costly and inefficiently.

A computer system allowing the BMC 12 to directly reach other devices in a peer-to-peer transmission mode, although being able to exempted from the above problem, is high in manufacturing cost.

### SUMMARY OF THE INVENTION

Therefore, it is an object of the present invention to provide a computer system allowing maintenance thereof from a remote terminal via the BMC even if simple LPC downstream transmission is performed.

A first aspect of the present invention relates to a peripheral management system comprising a system chip, a peripheral I/O control device and a control management device. The control management device is electrically connected between the system chip and the peripheral I/O device in series, and asserts a first processing signal to the peripheral I/O control device in response to a control signal from the system chip in a first state, and assets a second processing signal to the peripheral I/O control device in response to an external control signal in a second state.

For example, the peripheral management system can be a part of a computer system; the control management device can be a baseboard management controller (BMC); a bus applied to the peripheral management system can be a low pin count (LPC) bus; the system chip can be a south bridge chip; the peripheral I/O control device comprises a control management memory, a system BIOS and a super I/O control device; and the control management memory and the system BIOS are both flash memories.

The super I/O control device is preferably for controlling at least a keyboard, a mouse, a floppy disc drive and a communication port.

Preferably, the external control signal is asserted by a remote terminal.

In one embodiment, the first state is a normally operational state of the peripheral management system, and the second state is a crash state of the peripheral management system.

More particularly, the first and the second states are a normally operational state and an idle state of the system BIOS. In this case, the external control signal can be a remote BIOS update request signal for updating the system BIOS so as to recover from the second state to the first state.

In one embodiment, the first and the second states are a normally operational state and an idle state of the system chip. The external control signal can be a remote super I/O control signal for controlling the input/output operation of the super I/O control device.

Preferably, the control management device asserts a third processing signal in a third state.

In one embodiment, the third processing signal is transmitted from the control management device to the system chip in response to another external control signal. The another external control signal can be a remote simulation control signal for simulating the input/output operation of the super I/O control device.

In one embodiment, the third processing signal is actively generated by the control management device to be exclusively provided for the system chip.

According to a second aspect of the present invention, a peripheral management system comprises a system chip, a peripheral I/O control device and a control management device, and the control management device is electrically connected between the system chip and the peripheral I/O device in series. The control management device asserts a first processing signal to the system chip in response to an external control signal at a first state.

Preferably, the external control signal is asserted by a remote terminal.

Preferably, the control management device actively generates and asserts a second processing signal to the system chip in a second state.

According to a third aspect of the present invention, the peripheral management system comprises a system chip, a control management device, an LPC bus and a peripheral I/O control device electrically interconnected in series. The control management device asserts a processing signal to be upstream transmitted to the system chip or downstream transmitted to the peripheral I/O control device via the LPC bus when the system chip is in a crash state.

### BRIEF DESCRIPTION OF THE DRAWINGS

The present invention may best be understood through the following description with reference to the accompanying drawings, in which:

FIG. 1 is a schematic block diagram showing a partial computer system associated with the management of an I/O control device via LPC transmission in the prior art;

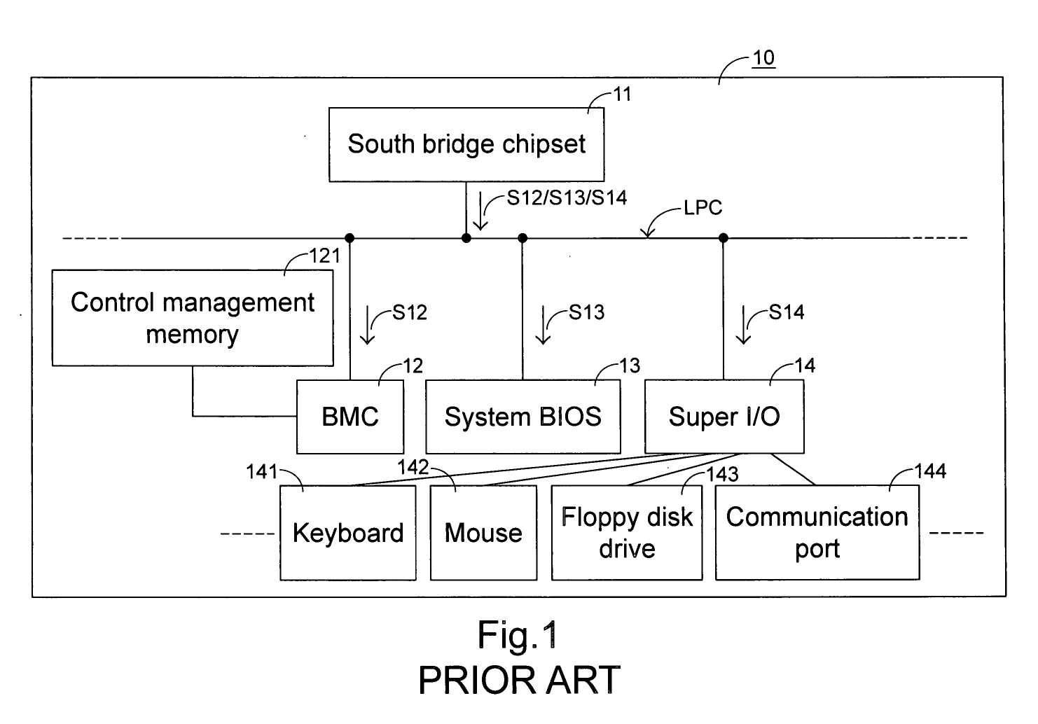

FIG. 2A is a schematic block diagram showing a partial computer system associated with the management of an I/O control device in an LPC downstream transmission mode according to the present invention; and

FIG. 2B is a schematic block diagram showing a partial computer system associated with the management of an I/O control device in an LPC upstream transmission mode according to the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

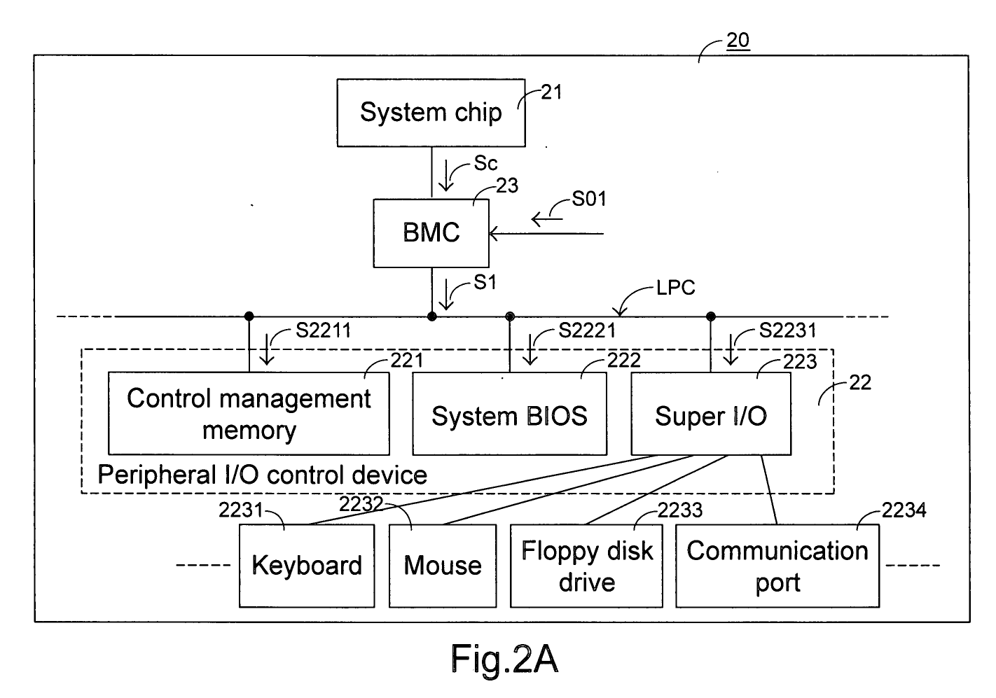

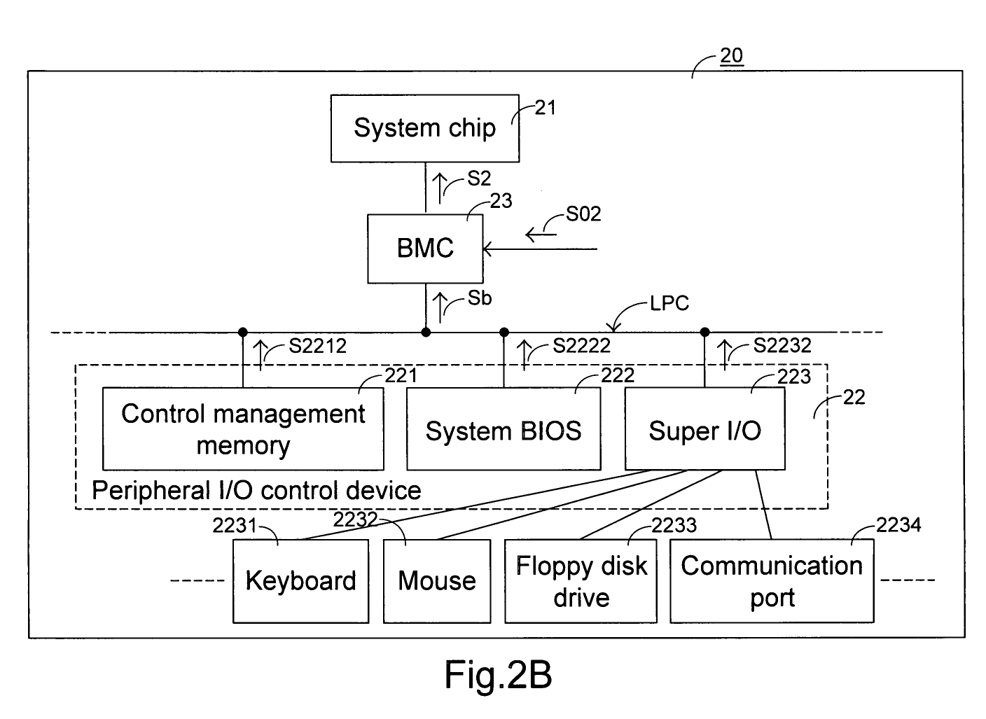

For cost consideration, LPC upstream and downstream transmission modes, other than a peer-to-peer mode, are adopted by the flash memory and peripheral manufacturers. For allowing maintenance from a remote terminal on condition that LPC upstream and downstream transmission is adopted, a peripheral management system is contemplated according to the present invention. An embodiment will be illustrated hereinafter with reference to FIGS. 2A and 2B

The peripheral management system in this embodiment is a part of a computer system 20, and comprises a system chip 21, a peripheral I/O device 22 and a management and control device 23 in communication with the system chip 21 and the peripheral I/O control device 22. The system chip 21, for example, is a south bridge chip. The control management device 23, for example, is a baseboard management controller (BMC). The peripheral I/O control device 22, for example, includes a control management memory 221 exclusively used by the BMC 23, a basic input/output system memory (also referred to system BIOS) 222 for storing BIOS firmware to be provided for the computer system via the south bridge chip 21 and the BMC 23, and an integral input/output (also referred to super I/O) control device 223 connected to a plurality of peripheral I/O devices such as a keyboard 2231, a mouse 2232, a floppy disc drive 2233 and a communication port 2234.

According to the present invention, the BMC 23 is coupled between the system chip 21 and the LPC bus, and arranged in series. FIG. 2A schematically shows an LPC downstream mode of the peripheral management system. Since the BMC 23 is disposed between the peripheral I/O control device 22 and the system chip 21, a system control signal Sc asserted by the system chip 21 is downward transmitted to the peripheral I/O control device 22 via the BMC 23. Alternatively, the BMC 23 can directly assert a processing signal S1 to the peripheral I/O control device 22 in an LPC downstream mode to manage the peripheral I/O control device 22. In other words, the control management memory 221, system BIOS 222 and super I/O control device 223 can be managed or controlled by the BMC 23 directly. Due to this feature, provided that the BIOS firmware stored in the system BIOS 222 is damaged so as to result in the crash of the system chip 21, it does not have to manually update the system BIOS 222 in order to recover the computer system. In stead, an external control signal S01 indicative of a remote BIOS update request is asserted from a remote terminal (not shown) to the BMC 23. In response to the external control signal S01, the BMC 23 asserts the processing signal S2211 downward to the system BIOS 222 to update the BIOS, thereby recovering the work of the system chip 21 and thus the computer system 20.

In another case that the processing signal S1 is asserted by the BMC 23 in response to another external control signal S01 indicative of remote super I/O control, the BMC 23 is able to control the input/output operation of the super I/O control device 223 via the processing signal S2231.

Further referring to FIG. 2B, an LPC upstream mode of the peripheral management system is schematically shown. The BMC 23, in addition to upward transmitting the signal Sb from the peripheral I/O control device 22 to the system chip 21, also transmits a processing signal S2 to the system chip 21 in response to an external control signal S02, thereby allowing the control from a remote terminal. The signal Sb can be one or more of the signals S2212, S2222 and S2232 generated from the control management memory 221, system BIOS 222 and super I/O control device 223, respectively. On the other hand, the processing signal S2 can also be the one actively generated by the BMC 23 to be exclusively provided for the system chip 21. The external control signal S02, for example, can be a remote simulation control signal. In response to the remote simulation control signal S02, the BMC 23 asserts the processing signal S2 to the system chip 21 to simulate the input/output operation of the super I/O control device 223.

From the above description, it is understood that by arranging the BMC between the system chip and the peripheral I/O control device 22 in series, the control management memory, system BIOS and super I/O control device can be managed or controlled by the BMC directly in the LPC upstream/downstream transmission architecture. Therefore, the system can be efficiently maintained in a remote manner.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A peripheral management system, comprising a system chip, a peripheral I/O control device and a control management device, said control management device being electrically connected between said system chip and said peripheral I/O device in series, and asserting a first processing signal to said peripheral I/O control device in response to a control signal from said system chip in a first state, and asserting a second processing signal to said peripheral I/O control device in response to an external control signal in a second state.

2. The peripheral management system according to claim 1 wherein said peripheral management system is a part of a computer system.

3. The peripheral management system according to claim 1 wherein said control management device is a baseboard management controller (BMC).

4. The peripheral management system according to claim 1 wherein a bus applied to said peripheral management system is a low pin count (LPC) bus.

5. The peripheral management system according to claim 1 wherein said system chip is a south bridge chip.

6. The peripheral management system according to claim 1 wherein said peripheral I/O control device comprises a control management memory, a system BIOS and a super I/O control device.

7. The peripheral management system according to claim 6 wherein said control management memory is a flash memory, and said system BIOS is a flash memory.

8. The peripheral management system according to claim 6 wherein said super I/O control device is for controlling at least a keyboard, a mouse, a floppy disc drive and a communication port.

9. The peripheral management system according to claim 1 wherein said first state is a normally operational state of said peripheral management system, and said second state is a crash state of said peripheral management system.

10. The peripheral management system according to claim 9 wherein said external control signal is asserted by a remote terminal.

11. The peripheral management system according to claim 1 wherein said peripheral I/O control device comprises a system BIOS, and said first and said second states are a normally operational state and an idle state of said system BIOS.

12. The peripheral management system according to claim 11 wherein said external control signal is a remote BIOS update request signal for updating said system BIOS so as to recover from said second state to said first state.

13. The peripheral management system according to claim 1 wherein said peripheral I/O control device comprises a super I/O control device, and said first and said second states are a normally operational state and an idle state of said system chip.

14. The peripheral management system according to claim 13 wherein said external control signal is a remote super I/O control signal for controlling the input/output operation of said super I/O control device.

15. The peripheral management system according to claim 1 wherein said control management device asserts a third processing signal in a third state.

16. The peripheral management system according to claim 15 wherein said third processing signal is transmitted from said control management device to said system chip in response to another external control signal.

17. The peripheral management system according to claim 16 wherein said peripheral I/O control device comprises a super I/O control device, and said another external control signal is a remote simulation control signal for simulating the input/output operation of said super I/O control device.

18. The peripheral management system according to claim 15 wherein said third processing signal is actively generated by said control management device to be exclusively provided for said system chip.

19. A peripheral management system, comprising a system chip, a peripheral I/O control device and a control management device, said control management device being electrically connected between said system chip and said peripheral I/O device in series, and asserting a first processing signal to said system chip in response to an external control signal in a first state.

20. The peripheral management system according to claim 19 wherein said external control signal is asserted by a remote terminal.

21. The peripheral management system according to claim 19 wherein said control management device actively generates and asserts a second processing signal to said system chip in a second state.

22. A peripheral management system, comprising a system chip, a control management device, an LPC bus and a peripheral I/O control device electrically interconnected in series, said control management device asserting a processing signal to be upstream transmitted to said system chip or downstream transmitted to said peripheral I/O control device via said LPC bus when said system chip is in a crash state.
